(19) United States
(12) Patent Application Publication
(10) Pub. No.: US 2009/0295545 A1
(43) Pub. Date: Dec. 3, 2009

(54) Method and System for Variable Operation of RFID-Based Readers Utilizing a Trigger Setting

(76) Inventors: Michael O'HAIRE, Smithtown, NY (US); Thomas Wulff, North Patchogue, NY (US); David Bellows, Wantagh, NY (US)

Correspondence Address: MOTOROLA, INC., 1303 EAST ALGONQUIN ROAD, IL01/3RD, SCHAUMBURG, IL, 60196, US

(21) Appl. No.: 12/132,297

(22) Filed: Jun. 3, 2008

(51) Int. Cl. H04B 7/00

(52) U.S. Cl. 340/10.5

(57) ABSTRACT

Described are a communication device and a method for variable operation of RFID-based readers. The communication device includes at least one radio frequency (“RF”) source transmitting an RF signal to at least one target within an operating field and receiving a data signal from the at least one target, at least one trigger activating the at least one RF source, the at least one trigger including a plurality of trigger configurations, each trigger configuration relating to the one or more operating settings, and an RF controller controlling one or more operating settings on the communication device, the RF microcontroller adjusting the setting based on at least one of the plurality of trigger configurations.

### FIELD OF INVENTION

The present application generally relates to systems and methods for varying the operation of an electronic device, such as a radio frequency identification (“RFID”) reader. Specifically, the exemplary system and methods may allow a radio frequency (“RF”) controller within an RFID reader to adjust one or more variables (e.g., attenuation level) during RFID tag reading based on a trigger position on the RFID reader.

### BACKGROUND

RFID technology includes systems and methods for non-contact reading of targets (e.g., products, people, vehicles, livestock, etc.) in order to facilitate effective management of these targets within a business enterprise. Specifically, RFID technology allows for the automatic identification of targets, storing target location data, and remotely retrieving target data through the use of RFID tags, or transponders. The RFID tags are an improvement over standard bar codes since the tags may have read and write capabilities. Accordingly, the target data stored on RFID tags can be changed, updated and/or locked. Due to the ability to track moving objects, RFID technology has established itself in a wide range of markets including retail inventory tracking, manufacturing production chain, and automated vehicle identification systems. For example, through the use of RFID tags, a retail store can see how quickly the products leave the shelves, and gather information on the customer buying the product.

Within an RFID system, the RFID tag may be a device that is either applied directly to, or incorporated into, one or more targets for the purpose of identification via radio signals. A typical RFID tag may contain at least two parts. A first part is an integrated circuit for storing and processing information, as well as for modulating and demodulating a radio signal. A second part is an antenna for receiving and transmitting radio signals including target data. A typical RFID reader may contain a radio transceiver and may be capable of receiving and processing these radio signals from several meters away and beyond the line of sight of the tag.

Passive RFID tags may rely entirely on the RFID reader as their power source. These tags are read from a limited range and may have a lower production cost. Accordingly, these tags are typically manufactured to be disposed with the product on which it is placed. Unlike the passive RFID tags, active RFID tags may have their own internal power source, such as a battery. This internal power source may be used to power integrated circuits of the tag and broadcast the radio signal to the RFID reader. Active tags are typically much more reliable than passive tags, and may be operable at a greater distance from the RFID reader. Active tags contain more hardware than passive RFID tags, and thus are more expensive.

### SUMMARY OF THE INVENTION

The present invention relates to a communication device and a method for variable operation of RFID-based readers. The communication device includes at least one radio frequency (“RF”) source transmitting an RF signal to at least one target within an operating field and receiving a data signal from the at least one target, at least one trigger activating the at least one RF source, the at least one trigger including a plurality of trigger configurations, each trigger configuration relating to the one or more operating settings, and an RF controller controlling one or more operating settings on the communication device, the RF microcontroller adjusting the setting based on at least one of the plurality of trigger configurations. The method includes determining at least one trigger configuration of at least one trigger of a communication device, wherein each trigger configuration relates to one or more operating settings of the communication device, and adjusting the operating setting of the communication device based on the determined trigger configuration.

### BRIEF DESCRIPTION OF THE DRAWINGS

FIG. 1A shows an exemplary embodiment of an electronic device, such as an RFID reader, according to the present invention.

FIG. 1B shows a further exemplary embodiment of an electronic device, such as an RFID reader, according to the present invention.

FIG. 2 shows an exemplary system for varying the operation of an electronic device, such as an RFID reader, according to the exemplary embodiments of the present invention.

FIG. 3A represents an exemplary method for varying the operation of an electronic device, such as an RFID reader, according to the exemplary embodiments of the present invention.

FIG. 3B represents an exemplary method for adjusting a power level of an RFID reader based on a trigger position on the RFID reader according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The present invention is related to systems and methods used for adjusting the system settings of an electronic device, such as a handheld mobile radio frequency identification (“RFID”) reader. Specifically, the exemplary systems and methods may allow a radio frequency (“RF”) controller within an RFID reader to adjust one or more parameters during RFID tag reading based on a trigger position on the RFID reader. The adjustment made to the system parameters may include adjusting the read attenuation level (e.g., the power level), tag filtering, a selection of an antenna utilized, a number of antennas utilized, enablement of tag protocols, utilization of link profiles, Q Value, Duty Cycle, etc. Thus, a user of the electronic device may alter the desired behavior and operation of the device based on which trigger, or which trigger position is currently being depressed by the user. This is easier and quicker than receiving user input via a keyboard or a touch screen.

One skilled in the art of RFID technology understands that while using a handheld RFID reader, all RFID tags within range of the reader will be read. However, this is not always the desired operation. In fact, sometimes a user may want to read all of the tags, while other times the user wants to limit the number of tags being read. The exemplary embodiments of the present invention allow the user to alter the desired behavior and operating conditions of the RFID reader based on a trigger position and/or a trigger configuration of one or more triggers on the RFID reader. Thus, the user may easily achieve the desired tag reading behaviors.

According to one exemplary embodiment of the present invention, the exemplary systems and methods offer the ability to manage the attenuation level of the RFID reader in order to adjust an operating field for reading RFID tags. In other words, the RFID reader may utilize variable power settings in the RFID transceiver, wherein the setting may be selected based on user input at the RFID reader. The user input may be accomplished through the detection of a change in a trigger position and/or a trigger configuration on the RFID reader. Thus, while using the RFID reader, a user may allow for selective reading of RFID tags that are within range of the RFID reader. For example, a user may want to switch from reading all of the tags within range of the RFID reader to reading a limited number of tags within range.

As will be described in greater detail below, an exemplary RFID reader may include one or more triggers, wherein each trigger may have multiple trigger positions. These trigger positions may include full depression of the trigger for full power setting, half depression of trigger for limited power setting, no depression of the trigger for deactivating the power setting, etc. Each of the triggers may correspond to a desired behavior or operating condition of the reader, such as, for example, adjusting a power setting on the reader. In addition, as will be described in greater detail below, alternative embodiments of the present invention may implement the use proximity detectors for altering the operating settings of the RFID reader based on measured distances from the reader to one or more targets (e.g., RFID tag(s))

Furthermore, it should be noted that while the exemplary systems and methods described herein discuss the use of two power settings, the present invention is not limited to only two settings. Accordingly, the exemplary embodiments may have several power settings, each having a corresponding operating field.

The exemplary embodiments of the present invention allow for improved utility of RFID readers within a mobile device. Those skilled in the art will understand that the RFID readers according to the present invention may also be used to describe RFID readers within any type of electronic device in accordance with the principles and functionality described herein. For example, the exemplary embodiments may also be implemented in a stationary fixed mount device. Thus, the use of a mobile RFID reader is only exemplary.

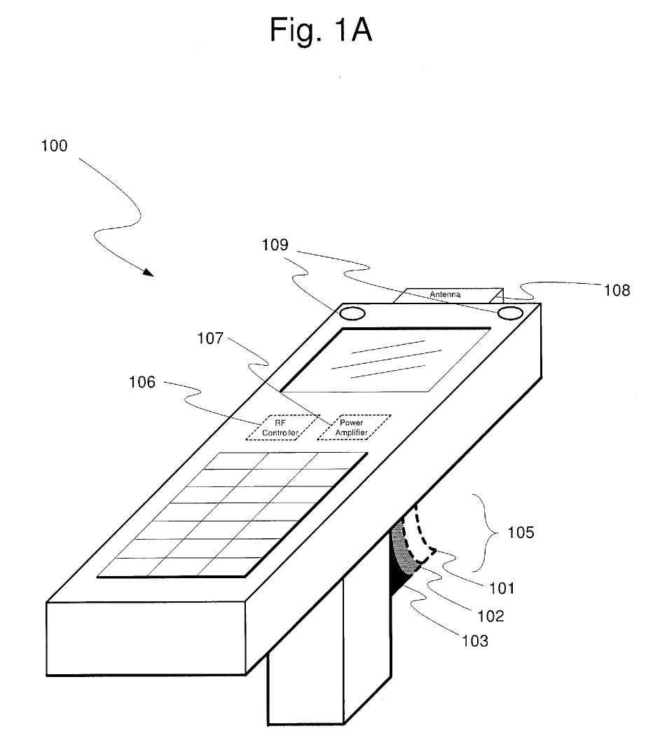

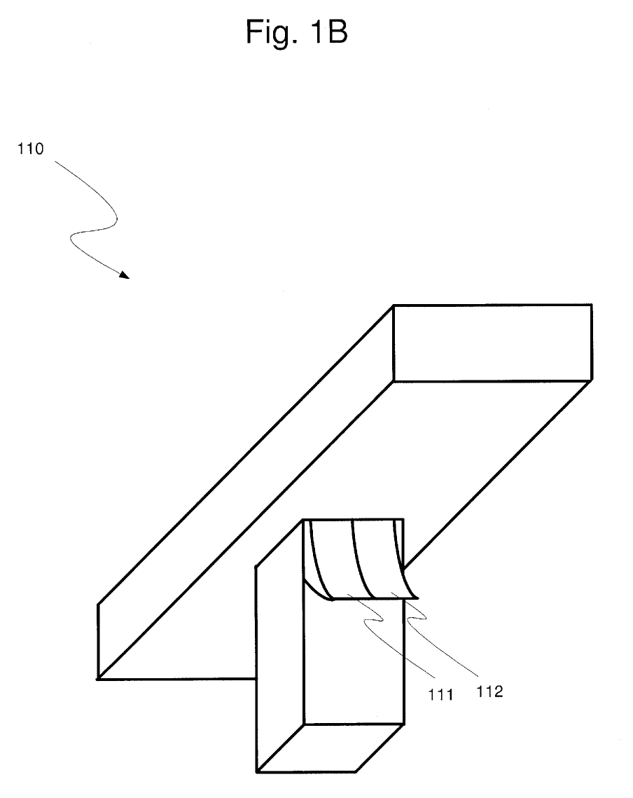

FIG. 1A shows an exemplary embodiment of an electronic communication device, such as a handheld mobile RFID reader 100, according to the present invention. According to the exemplary embodiment, FIG. 1A shows a perspective view of the RFID device 100, wherein the device 100 includes a trigger 105. The trigger 105 may be a multi-position trigger used for controlling the operation of the RFID reader 100. As described above, the RFID reader 100 may include circuitry that actively adjusts the operating settings depending on the position of the trigger 105. For example, the RFID reader 100 may include further components such as an RF controller 106, a power amplifier (“PA”) 107, and an antenna 108. In addition, alternative embodiments of the RFID reader 100 may further include one or more proximity detectors 109. The proximity detectors 109 will be described in greater detail below.

According to the exemplary embodiments of the RFID reader 100, the RF controller 106 may transmit a signal to the PA 107 for transmission via the antenna 108. This circuitry may allow for the RF controller 106 to detect a trigger position (e.g., positions 101, 102, 103, etc.) of the trigger 105. Based upon this position, the RF controller 106 may adjust the amount of power at the PA 107 prior to transmitting a data signal from the antenna 108. Accordingly, the RFID reader 100 may dynamically adjust the output power setting prior to initiation any communication with an RFID tag. It should be noted that while FIG. 1 shows the RFID reader 100 utilizing a single antenna 108, the reader 100 may implement the use of any number of antennas. Accordingly, in a multi-antenna configuration, the position of the trigger 105 may alter the activation of the type of antenna(s), as well as the number of antennas, used during an RFID scanning session.

It should be noted that while FIG. 1 illustrates the trigger 105 as having three distinct trigger positions 101-103, the exemplary embodiments of the present invention may utilize any number of trigger positions for altering the operation of the RFID reader 100. For example, according to additional embodiments of the RFID reader 100, the trigger 105 may be a pressure sensitive trigger wherein the operation of the RFID reader 100 will vary based on a degree of pressure applied to the trigger 105. Therefore, a user may apply a minimal degree of pressure to the trigger 105 in order to activate a small read range of the RFID reader 100. As the user increases the degree of pressure applied to the trigger 105, the area of the read range may increase. Specifically, a greater amount of power may be supplied to the antenna(s) 108 as the user applies greater power to the pressure sensitive trigger 105. Accordingly, as opposed to having a set number of discrete trigger positions (e.g., positions 101-103), the trigger 105 may have an infinite number of trigger position correlated to the amount of pressure applied by a user to the trigger 105.

In addition, the trigger 105 may detect a location of a user's finger and/or a number of fingers on the surface of the trigger 105. Specifically, the surface of the trigger 105 may include a touch panel. Accordingly, the location of a finger and/or the number of fingers on the trigger 105 may alter the operation of the RFID reader 100 as the trigger 105 is depressed by the user. For example, the touch panel on the trigger 105 may distinguish a higher finger location on the trigger 105 from a lower finger location. The higher finger location may adjust one or more operating conditions of the RFID reader 100, such as by increasing the output power of the antenna(s) 108, while the lower finger location may also adjust conditions, such as by decreasing the output power of the antennas(s) 1-8. In addition, or in the alternative, the touch panel may distinguish the use of any number of fingers, such as the use of an index finger, a middle finger, both the index and middle fingers, etc. Accordingly, each detectable finger setting may activate or adjust vary operating conditions of the RFID reader 100.

As described above, a trigger position or configuration may also alter which antenna is selected and activated. According to one embodiment of the RFID reader 100, trigger position 102 may activate a horizontally polarized antenna, while trigger position 103 may activate a vertically polarized antenna. In addition, another trigger position may activate a mode wherein the operating condition switches between multiple antennas, such as the vertically polarized antenna and the horizontal polarized antenna. Furthermore, a further trigger position may activate both a vertically polarized antenna and a horizontally polarized antenna, thereby created a circular polarized signal. Thus, the RFID reader 105 may operate with a linear polarized antenna (e.g., either horizontally or vertically polarized), and may operate with a circular polarized antenna (e.g., both horizontally or vertically polarized). As will be described in greater detail below, the user may vary the actual type of antenna based on the position/configuration of the trigger 105. As a further example, one trigger position may be a low gain setting, while a further trigger position may be a high gain setting, etc.

Accordingly, the functions of the RF controller 106 may include managing the output power from the antenna 108, adjusting the power level of the PA 107, and monitoring a trigger configuration of the trigger 105. Specifically, the RF controller 106 may regulate the operation of the RFID reader 100 by facilitating communications between the various components. For example, the RF controller 106 may include a microprocessor, an embedded controller, a further application-specific integrated circuit, a programmable logic array, etc. The controller 106 may perform data processing, execute instructions and direct a flow of data between devices coupled to the RF controller 106. As will be explained below, the RF controller 106, according to the exemplary embodiments of the present invention, may be used to configure various parameters of the RFID reader 100.

When a user activates the RFID reader 100 via the trigger 105, the RF controller 106 may detect a plurality of trigger positions. These trigger positions may include a fully depressed position 103, a partially (e.g., halfway) depressed position 102, and a released position 101. Each of these trigger positions 101-103 may determine the power level, or attenuation level, of output signal from the RFID reader 100 for communicating with RFID tags within an operating field. For example, the fully depressed position 103 may activate a high power output signal, wherein the operating field of the RFID reader 100 may be of a large area. The partially depressed position 102 may activate a lower power output signal, wherein the operating field of the RFID reader 100 may be of a smaller area. The released position 102 may deactivate the output signal, wherein the RFID reader 100 may not communicate with any tags.

It should be noted that on the way to the fully depressed position 103, the trigger 105 may pass through the partially depressed position 102. Accordingly, the output signal may initially be set to a lower power level once the trigger 105 in depressed. As the trigger 105 transitions from the partially depressed position 102 to the fully depressed position 103, the power level of the output signal may be increased to a higher power level. In an alternative embodiment, the RFID reader 100 may wait for the trigger 105 to remain at a particular position for a predetermined period of time prior to selecting and applying an output power level.

FIG. 1B shows a further exemplary embodiment of an electronic device, such as a handheld mobile RFID reader 110, according to the present invention. According to the exemplary embodiment, FIG. 1B shows a perspective view of the RFID reader 110, wherein the device 110 includes multiple triggers, such as a first trigger 111 and a second trigger 112. Similar to the RFID reader 100, the RFID reader 110 may include further components such as an RF controller, a PA, and an antenna. Accordingly, the RFID reader 110 may include circuitry that actively adjusts the operating settings depending on which of the triggers 111 and 112 are depressed by the user. This circuitry of the RFID reader 110 may allow for the RF controller to detect the depression of one of the triggers 111 and 112. Based upon this depression, the RF controller may adjust the amount of power at the PA prior to transmitting a data signal from the antenna. Accordingly, the RFID reader 110 may dynamically adjust the output power setting prior to initiation any communication with an RFID tag. According to an alternative embodiment of the RFID reader 110, each of the multiple triggers 111 and 112 may be a multi-position triggers, similar to the trigger 105 of FIG. 1B. Thus, these multi-position triggers may be used for further controlling the operation of the RFID reader 110.

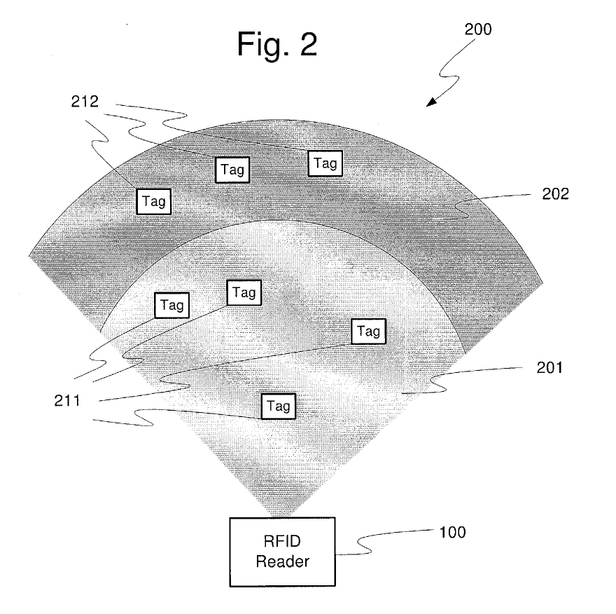

FIG. 2 shows an exemplary system 200 for varying the operation of an electronic device, such as an RFID reader 100, according to the exemplary embodiments of the present invention. The exemplary system 200 will be described with reference to the exemplary RFID reader 100 of FIG. 1A. As illustrated in FIG. 2, the system 200 may include at least two operating fields, namely a near field 201 and a far field 202. Furthermore, the system 200 may include a plurality of tags, such as one or more near tags 211 and one or more far tags 212, each of which may be readable by the RFID reader 100. It should be noted that the area of the operating field used by the RFID reader 100 may be dependent on the power level, or attenuation level, provided to an antenna (e.g., a transceiver) within the RFID reader 100. Specifically, a lower power level may create a small operating field, such as near field 201, while a higher power level may create a large operating field, such as far field 202.

A user may decide which operating fields 201 and 202 should be used while the RFID reader 100 is reading tags 211 and 212. As described above, the user may change a trigger position and/or a trigger configuration on the RFID reader 100 in order to select the operating setting of the reader 100. In a multi-position trigger, such as trigger 105, a first trigger position may set the output power of the RFID reader 100 to a high power setting. At a high power setting, the RFID reader 100 may create the far field 202, thereby allow for all the tags (e.g., tags 211 and 212) within that field to be read. A second trigger position may lower the power setting to limit the RFID reader 100 to reading the tags that are closer (e.g., tags 211). As described above, an alternative embodiment of the RFID reader 100 may utilize multiple triggers as the various trigger configurations.

It should be noted that while the above system 200 may allow a user of the RFID reader 100 to adjust the power level at the antenna, several additional settings of the RFID reader 100 may be adjusted based on trigger position and/or trigger configurations. For example, the system 200 may allow a user to activate a tag filtering process. Specifically, the first trigger position may read all of the tags in a field, while a second trigger position may only read tags to meet a predetermined filtering condition. Furthermore, the system 200 may also allow a user to determine the closest tag to the RFID reader 100. Specifically, the first trigger position may read all of the tags, and a second trigger position may read only the tag that is read the most time while the first trigger position is used. Thus, while conventional RFID readers may read every tag within range of the reader, the exemplary embodiments of the present invention allows the user to limit the number of tags that are to be read, based on a specific criteria selected by the user. The specific criteria may be implemented through the use of custom software for automatic configuration or through manual intervention by the user.

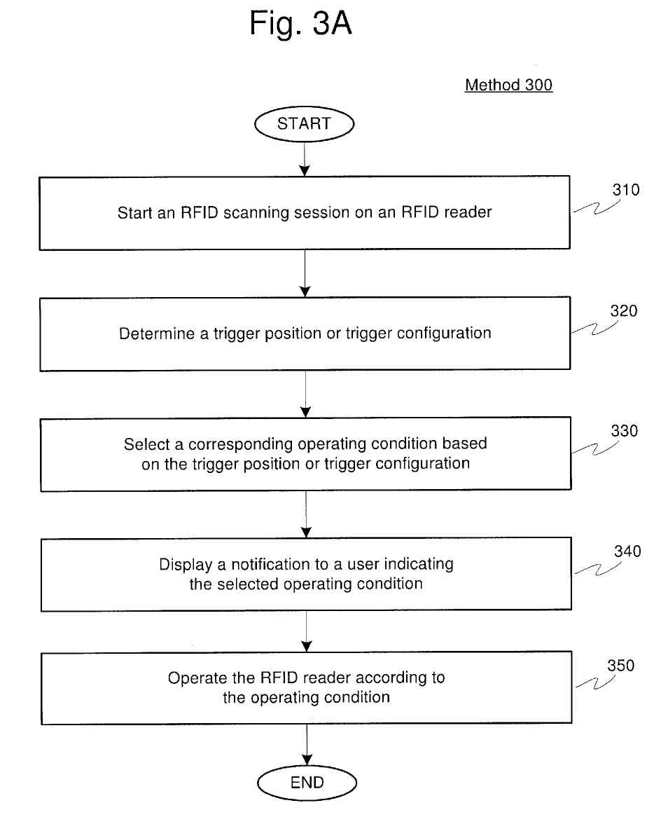

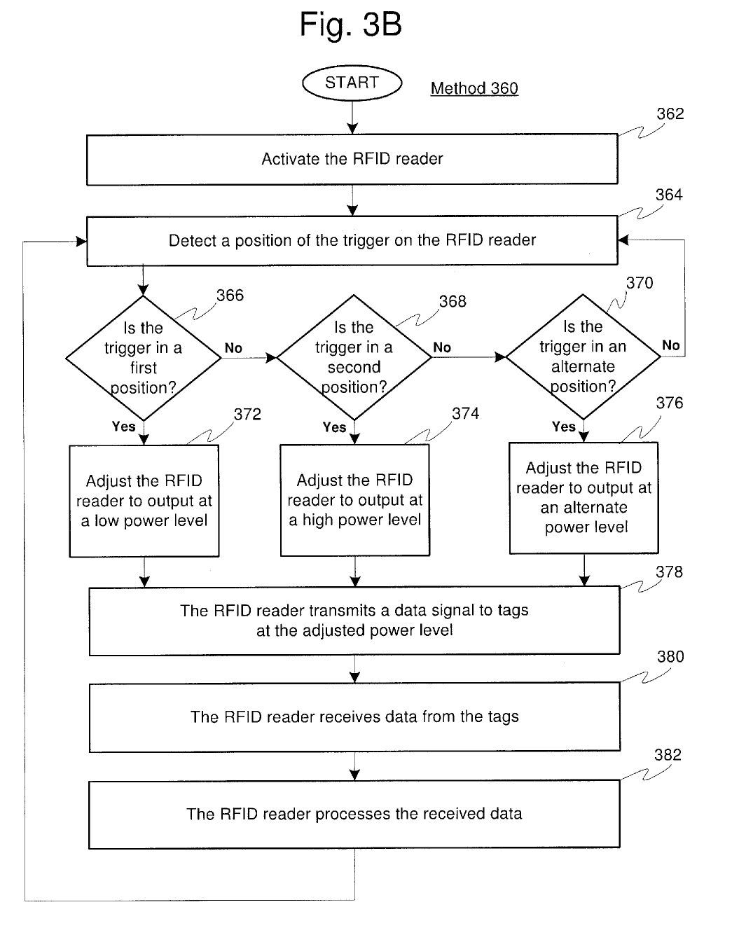

FIG. 3A represents an exemplary method 300 for optimizing the performance of an electronic device, such as the RFID reader 101 according to the exemplary embodiments of the present invention. The exemplary method 300 will be described with reference to the exemplary system 100 of FIG. 1. As described above, the electronic device may include multiple triggers and/or multi-position triggers that alter the behavior of the device during a user's operating session. The altered behavior may include adjusting a power level setting of an antenna, applying a filtering protocol for communicating with other electrical devices, adjusting the number of antennas utilized by the electrical device, etc.

In step 310, the method 300 may start an RFID scanning session. A scan session may be described as the period in which the RFID reader 100 communicates with one or more RFID tags located within operating range of the reader 100. The session may include a forward link communication from the reader 100 to the tag(s) and a reverse link communication from the tag(s) back to the reader 100. Accordingly, the session may be initiated when a user activates the RF controller 106 within the RFID reader 100. For example, the user may depress the trigger 105 to start the scanning session.

In step 320, the method 300 may determine a trigger position and/or trigger configuration of the trigger(s) on the RFID reader. As described above, the user may position the trigger 105 in a number of configurations, such as in a fully depressed position 103, a partially depressed position 102, and a released position 101. Alternatively, the RFID reader 100 may include a plurality of triggers depressible by the user, wherein the trigger configurations may include the use of one of the triggers. In addition, the trigger configuration may include further alternatives, such as a detected location of a user's finger on the trigger(s), a detected number of fingers used on the trigger(s), detectable position on one or more pressure sensitive triggers, etc. Accordingly, the RFID reader 100 may be programmed to recognize each of trigger configurations as relating to one or more operation settings for the RFID reader 100.

In step 330, the method 300 may select a corresponding operating condition based on the detected trigger position/configuration. As described above, the operating condition may include setting the output power of the antenna. The selection of output power may allow the RFID reader 100 to vary the operating range of the antenna. For example, the operating range may include a near field and a far field. However, it should be noted that the terms “near” and “far” are relative terms referring to the settings of the device in relation to, for example, a plurality of tags in an operating environment. The actual settings for each of these conditions and any other adjustable conditions may depend on the specifics of the individual RFID device.

While the above-described embodiment for method 300 indicates that the operating condition may include setting an output power of the antenna, the method 300 may be used to adjust any number of operating conditions of the RFID reader 100. For example, as discussed above, the trigger position and/or trigger configuration may correspond to an activation and deactivation of one of more antennas 108 on the RFID reader 100. Accordingly, one antenna on the reader 100 may be a horizontally polarized antenna, having an electric field parallel to the Earth's surface. A further antenna on the reader 100 may be vertically polarized, having an electric field perpendicular to the Earth's surface. Therefore, a user may implement one trigger position/configuration to perform a horizontal reading of RFID tags within range and a further trigger position/configuration to perform a vertical reading of RFID tags within range. In addition, another trigger position may activate a mode wherein the operating condition switches between multiple antennas, such as the vertically polarized antenna and the horizontal polarized antenna. Furthermore, another trigger position/configuration may activate both of the antennas to create a circular polarization for reading of RFID tags within range. Thus, the operating condition may include a selection of which antenna is activate, as well as how many antennas are activated based on the user's input on the trigger(s) 105.

In step 340, the method 300 may display a notification to the user indicating the selected operating condition of the RFID reader. In other words, the RFID reader 100 may provide the user with feedback as to which operation setting(s) have been adjusted. For example, one notification may inform the user that the RFID reader 100 is currently detecting tags within a near field, while a further notification may inform the user that the reader 100 is operating with a far field. Accordingly, the notification may allow the user to confirm that the RFID reader 100 has detected an appropriate trigger configuration. Furthermore, the notification may inform the user as to various operation settings available as the user changes the trigger configurations. For example, the user may not be aware of additional operation settings that are available. Thus, changing the configuration of the trigger(s) may demonstrate these settings to the user.

In step 350, the method 300 may operate the RFID reader according to the selected operating setting(s), or condition. As described above, these conditions may determine the power level, or attenuation level, of output signal from the RFID reader 100 for communicating with RFID tags within an operating field. Additional conditions may allow a user to activate a tag filtering process, wherein one trigger configuration may read all of the tags in a field, while a second trigger configuration may only read tags to meet a predetermined filtering condition. The specific conditions may be fully adjustable by the user and may be implemented through the use of custom software for automatic configuration or through manual intervention by the user.

FIG. 3B represents an exemplary method 360 for adjusting a power level of an RFID reader based on a trigger position on the RFID reader according to the exemplary embodiments of the present invention. In step 362, the user may activate the RFID reader. The activation of the RFID reader 100 may be performed by any standard function, such as through an on/off switch on the device, through depressing the trigger 105, etc.

In step 364, the RFID reader 100 may detect a trigger position of the trigger. As described above, the user may manipulate the trigger 105 into multiple positions, wherein each position utilized by the user may offer a method for assigning different behaviors or operation settings, such as an output power of the antenna 108.

In steps 366-370, a determination may be made as to the trigger position. Specifically, if it is determined in step 366 that the trigger is in a first position (e.g., partially depressed position), then the method 360 may advance to step 372 wherein the output level of the RFID reader 100 may be set to a low level. If the trigger is not in the first position, the method 360 may advance to step 368. If it is determined in step 368 that the trigger is in a second position (e.g., fully depressed position), then the method 360 may advance to step 374 wherein the output level of the RFID reader 100 may be set to a high level. If the trigger is not in the second position, the method 360 may advance to step 370. If it is determined in step 370 that the trigger is in an alternative position (e.g., release position or a further degree of depression), then the method 360 may advance to step 376 wherein the output level of the RFID reader 100 may be set to an alternative power level (e.g., an off setting or further power level). If the trigger is not in the alternative position, the method 360 may return to step 364. Following the adjustment of the output level in one of steps 372, 374, and 376, the method 360 may advance to step 378.

In step 378, the RFID reader may transmit a data signal to one or more RFID tags at the adjusted power level. specifically, the RFID reader 100 may transmit modulated RF energy to the tag(s) across the forward link, towards the tag(s). In step 380, the RFID reader may receive data from the one or more tags. Specifically, the data received from the tag(s) may be communication to the RFID reader 100 across a reverse link, from the tag(s). While the reverse link is active, the RFID reader 100 may be transmitting continuous wave RF energy confined to a small spectrum range. Finally, in step 382, the RFID reader may process the received data.

As described above, the RF controller 106 may adjust the PA 107 of the RFID 100 based on these trigger configurations. As opposed to conventional RFID scanning devices that only utilize a single power setting, the exemplary embodiments of the present invention allow the RF controller 106 to dynamically adjust the power level based on a user input. For example, a conventional RFID scanning device may have a fixed operating field of 20 meters. However, this operating field may be too large an area for the desired operation of the user. For instance, the large field may detect every tag within range of the RFID reader while the user desires to limit the number of tag detected. Accordingly, the high power level, or attenuation level, associated with the large operating field needs to be adjusted. Therefore, according to exemplary embodiments of the present invention, the RF controller 106 may adjust the power level to narrow the operating field, such as to 10 meters, thereby narrowing the range of the antenna 108 of the RFID reader 100. Having a smaller operating field may allow the user to limit the number of tags detected by the RFID reader 100. Therefore, the various trigger configurations may be used to efficiently adjust the settings of the reader 100 according to the desired operation of the user.

According to an alternative embodiment of the present invention, the RFID reader 100 may include proximity detectors 109 for altering the operating settings of the reader 100 based on measured distances from the reader 100. Specifically, the proximity detectors 109 may provide the RF controller 106 with a best estimate of the range information for a desired tag. For example, the range information may lie in one of a plurality of coarse range categories in order to estimate the range to the targeted tags (e.g., near-range, mid-range, far-range, etc.). Each of the range categories may relate to an operating setting of the RFID reader 100, such as an output power level of the antenna 108. While the alternative embodiments utilize three varying range settings based on the receiver gain measurement, the exemplary systems and methods of the present invention may utilize any number of range settings, wherein each range setting may have distinct operating settings for the RFID reader 100.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A communication device, comprising:
at least one radio frequency (“RF”) source transmitting an RF signal to at least one target within an operating field and receiving a data signal from the at least one target;
at least one trigger activating the at least one RF source, the at least one trigger including a plurality of trigger configurations, each trigger configuration relating to the one or more operating settings; and
an RF controller controlling one or more operating settings on the communication device, the RF controller adjusting the setting based on at least one of the plurality of trigger configurations.

2. The communication device according to claim 1, wherein the setting is an output power level of the RF source, and the output power level is adjusted by the RF controller based on at least one of the trigger configurations.

3. The communication device according to claim 2, wherein a first trigger configuration activates a low output power level setting, and a second trigger configuration activates a high output power level setting.

4. The communication device according to claim 2, further comprising:
a power amplifier operating at a current power level coordinated with one of the plurality of trigger configurations.

5. The communication device according to claim 1, wherein the at least one trigger is a multi-position trigger, and the trigger configuration is one of a plurality of trigger positions.

6. The communication device according to claim 1, wherein the at least one trigger is a pressure sensitive trigger, and the trigger configuration is one of a degree of pressure applied to the pressure sensitive trigger.

7. The communication device according to claim 1, wherein the communication device includes a plurality of triggers and the trigger configuration is a depression of one of the plurality of trigger.

8. The communication device according to claim 1, wherein the settings include at least one of a target filtering operation, an activation of the at least one RF source, a deactivation of the at least one RF source, a selection of a linear polarity of the at least one RF source, a selection of a circular polarity of the at least one RF source, a gain setting on the at least one RF source, an activation of a protocol, a deactivation of the protocol, and a utilization of one or more link profiles.

9. The communication device according to claim 1, wherein the communication device is a radio frequency identification reader and the at least one target is a radio frequency identification tag.

10. The communication device according to claim 1, further comprising:
at least one proximity detector providing the RF controller with a distance to the at least one target, the RF controller altering the operating settings of the communication device based on the distance.

11. A method, comprising:
determining at least one trigger configuration of at least one trigger of a communication device, wherein each trigger configuration relates to one or more operating settings of the communication device; and
adjusting the operating setting of the communication device based on the determined trigger configuration.

12. The method according to claim 11, wherein the communication device includes at least one radio frequency (“RF”) source transmitting an RF signal to at least one target within an operating field and receiving a data signal from the at least one target, and the communication device further includes an RF controller controlling one or more operating settings on the communication device, the RF controller adjusting the setting based on at least one of the plurality of trigger configurations.

13. The method according to claim 11, wherein the setting is an output power level of the RF source, and the output power level is adjusted by RF the controller based on at least one of the trigger configurations.

14. The method according to claim 13, wherein a first trigger configuration activates a low output power level setting, and a second trigger configuration activates a high output power level setting.

15. The method according to claim 13, wherein the communication device further includes a power amplifier operating at a current power level coordinated with one of the plurality of trigger configurations.

16. The method according to claim 11, wherein the at least one trigger is a multi-position trigger, and the trigger configuration is one of a plurality of trigger positions.

17. The method according to claim 11, wherein the at least one trigger is a pressure sensitive trigger, and the trigger configuration is one of a degree of pressure applied to the pressure sensitive trigger.

18. The method according to claim 11, wherein the communication device includes a plurality of triggers and the trigger configuration is a depression of one of the plurality of trigger.

19. The method according to claim 11, wherein the settings include at least one of a target filtering operation, an activation of the at least one RF source, a deactivation of the at least one RF source, a selection of a linear polarity of the at least one RF source, a selection of a circular polarity of the at least one RF source, a gain setting on the at least one RF source, an activation of a protocol, a deactivation of the protocol, and a utilization of one or more link profiles.

20. The method according to claim 11, wherein the communication device is a radio frequency identification reader, and the at least one target is a radio frequency identification tag.

21. A system, comprising:
a determining means determining at least one trigger configuration of at least one trigger of a communication device, wherein each trigger configuration relates to one or more operating settings of the communication device; and
an adjusting means adjusting the operating setting of the communication device based on the determined trigger configuration.

22. The system according to claim 21, further comprising:
at least one radio frequency (“RF”) transceiving means transmitting an RF signal to at least one target within an operating field and receiving a data signal from the at least one target; and
an RF controlling means controlling one or more operating settings, the RF controller adjusting the setting based on at least one of the plurality of trigger configurations.
